(19) United States
(12) Patent Application Publication
(10) Pub. No.: US 2008/0294752 A1
(43) Pub. Date: Nov. 27, 2008

(54) Downloading of Data in Portable Communicating Objects Present in a Radio Communication Network During a Campaign

(75) Inventor: Eric Deschamps, Marseille (FR)

Correspondence Address: BUCHANAN, INGERSOLL & ROONEY PC, POST OFFICE BOX 1404, ALEXANDRIA, VA, 22313-1404, US

(73) Assignee: Gemplus, Gemenos (FR)

(21) Appl. No.: 12/091,887

(22) PCT Filed: Oct. 27, 2006
(86) PCT No.: PCT/EP06/67887

§ 371 Date: Jun. 13, 2008

(30) Foreign Application Priority Data
Oct. 31, 2005 (FR) 0553303

(51) Int. Cl. G06F 15/16

(52) U.S. Cl. 709/219

(57) ABSTRACT

A system downloads data made available in a campaign server to portable communicating objects across a radiocommunications network during a data downloading campaign. A campaign manager in the campaign server transmits campaign rules to a presence server connected to the radiocommunications network. A presence manager notifies the campaign server that an event relating to the presence of at least one communicating object in the radiocommunications network satisfies a campaign rule, in order to initiate a downloading of data from a campaign server to the available communicating object.

The present invention concerns the downloading of data from a campaign server in portable communicating objects over a radio communication network during a downloading campaign. In particular, it relates to a downloading of data when the portable communicating objects targeted by the campaign are deemed to be present in the radio communication network.

The portable communicating objects are chip cards, such as MMC (multimedia cards), SD (secure digital cards) and UICC (universal integrated circuit cards). The UICC chip card is for example a card provided with a SIM (subscriber identity module) application when the terminal is a mobile of the GSM or GPRS type, or a USIM (universal subscriber identity module), RUIM (removable user identity module) or ISIM (IP subscriber identity module) application, associated with mobile terminals functioning in third generation (3GPP) CDMA (code division multiple access) of the UMTS (universal mobile telecommunications system) or UTRAN (UMTS terrestrial radio access network) type, or third generation (3GPP2) of the CDMA 2000 type.

The campaign server for downloading data, also referred to as an OTA (over the air) card administration platform, comprises software that enables the operator managing the radio communication network to keep control of the chip cards in the mobile terminals and to modify their content. These operations at the initiative of the operator (push mode) concern for example the downloading of a file in predetermined cards in the stock managed by the operator, or the downloading or deletion of a given application, or the modification of data in a file or a given application in cards managed by the operator.

The invention is concerned more particularly with a campaign of massive downloading of data in user cards, although the campaign server can operate a single downloading in a user card.

According to a first example, downloading relates to a single personal file that is intended for itinerant users frequently situated abroad and which contains more than around ten preferred network identifiers managed by operators with whom the operator of the network managing the cards has contracted. The preferred network identifier file is unique and its purpose is to be downloaded into many predetermined user cards so that the cards of the users are preferably connected to these networks when the users are abroad.

For this first example, the operator currently has two possibilities for downloading this file from the campaign server. According to a first possibility, the operator decides to download the file in a unitary manner, in line with requirements, the first time a relevant user is roaming, and so on for all the users one after the other, who are roaming. According to a second possibility, referred to as campaign mode, the server sends the preferred network identifier file during a single campaign to the cards whose users have subscribed to a roaming option.

In campaign mode, the number of users targeted may be as much as hundreds of thousands or millions.

According to a second example, a downloading concerns an application facilitating the management of the list of telephone numbers in the cards. This application enables a user to save his entire list in a predetermined server managed by the operator and the saving is updated each time the user records a new telephone number in his card.

According to this second example, three possibilities are offered. Following advertising presented on television, the user calls the call centre of the operator during the day in order to request the downloading of the application in his card. This operation is a unitary operation triggered in the campaign server by the operator in customer-care mode.

According to a second possibility, the user takes the initiative to order downloadings by himself consulting the site of the operator from his mobile terminal so as to trigger the downloading of the application in the card. This downloading is also a unitary application controlled in the campaign server by the user in so-called self-care mode. According to a third possibility the operator triggers a downloading operation in campaign mode over a few thousands of targeted users so that the OTA server administers the downloading of the operation into all these cards.

For all the above downloadings from the campaign server, the establishment of a communication channel between the server and a card during a downloading campaign is decided by the operator and initiated in the server. These downloadings function in “push mode”.

According to a first embodiment of push mode, the downloading is effected by the sending of a series of short messages SMS, formatted by the campaign server according to a known protocol to a card, and then sent to the card over a telecommunications network of the GSM type of the operator. This embodiment is described in the French patent application 0410225 filed on 27 Sep. 2004 by the applicant and not published, entitled “Campaign for downloading data in portable communicating objects”. The establishment of the push mode communication, which requires the use of SMS technology, is a drawback for the networks whose infrastructures do not support short messages or for which short messages do not meet the standards necessary to a distant updating of cards, for example in CDMA (code division multiple access) networks. Another drawback is the unavailability of cards whose terminals are switched off or are outside the coverage of the radio communication network during the campaign, which requires numerous subsequent tests.

To remedy these drawbacks, a second embodiment consists of a downloading from a new-generation radio communication network of the GPRS or UMTS type over a data channel of the IP (internet protocol) type. A campaign server initiates a campaign for downloading data to numerous chip cards by sending a so-called “push SMS” short message to the cards. As soon as a card Cn has received the SMS message, it opens a communication channel by means of a mobile terminal housing the card and a gateway of the GGSN type (gateway GPRS support node) of a data network in order to initiate a session for communicating directly with the campaign server and receive the data to which the campaign relates.

A downloading campaign is often effected massively (a few million cards) over a relatively short period that may range from a few days to a few months, and thus results in a traffic peak on the radio communication network. During this period the network is highly stressed, which requires a well-sized infrastructure capable of supporting a temporary overload. Managing new tests without knowing whether the mobile terminal carrying the card is once again under the coverage of the network further increases the overload on the network.

The aforementioned drawbacks are remedied by a third embodiment described in French patent application 0552365 filed on 28 Jul. 2005 by the applicant and not published. This third embodiment changes the current push mode into a mode of interrogation by the card that during a downloading campaign initiates a communication with a campaign server in order to obtain a content made available by the operator of the radio communication network.

The objective of the invention is to remedy the aforementioned drawbacks by a downloading of data to at least one communication object, such as a card, targeted by the campaign when it is deemed to be present in the radio communication network for a period such that the campaign server can execute a downloading of the data provided in the communicating object. This has the advantage, amongst other things, of eliminating the management of retests by the downloading server and avoiding a traffic peak on the radio communication network due to the campaign.

To achieve this objective, a method for downloading data made available in a campaign server to portable communicating objects over a radio communication network during a data downloading campaign is characterised in that it comprises the steps of:

transmitting campaign rules relating to the campaign from the campaign server to a presence server, and

notifying by the presence server to the campaign server that an event relating to the presence of at least one communicating object in the radio communication network satisfies a campaign rule transmitted in order to initiate a downloading of the data from the campaign server to the communicating object present.

The invention can further optimise the massive campaigns launched from a campaign server by virtue of the transmission of campaign rules in the presence server connected to the radio communication network. A campaign rule can include at least one identifier of a communicating object targeted by the campaign and at least one presence condition for the communicating object in the radio communication network. The campaign rule thus identifies unambiguously a presence event for a communicating object, such as a chip card, targeted by the campaign in the radio communication network. This presence event indicates to the campaign server that the communicating object is available in the radio communication network for a sufficient predetermined period of connection of the communicating object to the radio communication network for receiving the data to be downloaded provided by the campaign.

According to another characteristic of the method of the invention, after transmission of the campaign rules by the campaign server to the presence server, the presence server combines each campaign rule relating to a communicating object targeted with presence rules relating to at least one timed range of accessibility of the said communicating object targeted so that an event relating to the presence of the communicating object targeted in the radio communication network satisfies both the campaign rules and the presence rules combined.

When it is detected that the campaign has ended, the campaign rules can be deleted in the presence server.

Another object of the invention is a system for downloading data made available in a campaign server to portable communicating objects over a radio communication network during a data downloading campaign. The system is characterised in that it comprises:

a means in the campaign server for transmitting campaign rules relating to the campaign to a presence server and

a means in the presence server for notifying to the campaign server that an event relating to the presence of at least one communicating object in the radio communication network satisfies a campaign rule transmitted in order to initiate a downloading of the data from the campaign server to the communicating object present.

The communicating objects may be removable user chip cards of mobile terminals, or mobile terminals.

According to a preferred embodiment, the radio communication network is a code division multiple access network CDMA, for example UMTS or UTRAN. According to another embodiment, the radio communication network is a GSM network back to back with a GPRS network.

The invention may not have recourse to an infrastructure comprising a short message server. The system of the invention may comprise a packet network without using short messages.

Finally, the invention relates to a computer program able to be used in a system for downloading data made available in a campaign server to portable communicating objects through a radio communication network during a data downloading campaign. The programme comprises instructions which, when the programme is executed in the said system, that is to say partly in the campaign server and partly in the presence server, perform the steps according to the method of the invention.

Other characteristics and advantages of the present invention will emerge more clearly from a reading of the following description of several preferred embodiments of the invention, given by way of non-limitative examples, with reference to the corresponding accompanying drawings, in which:

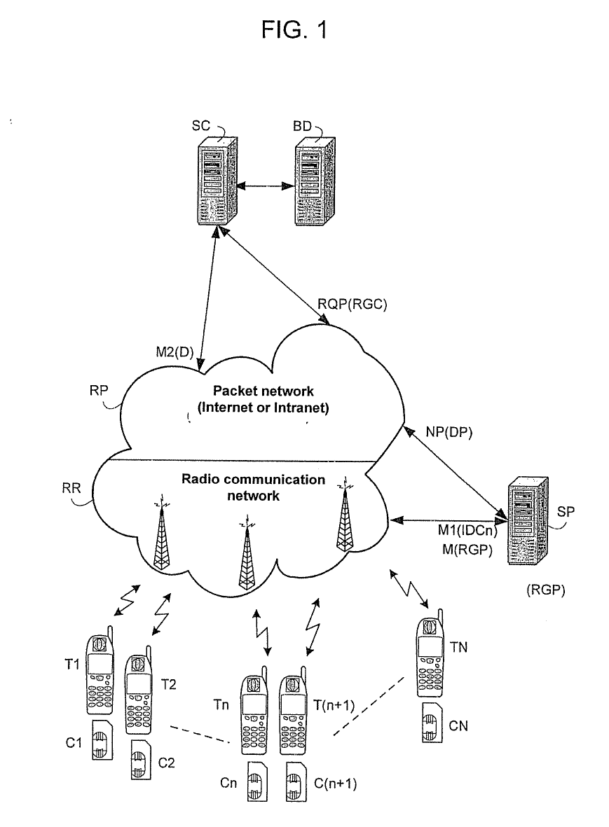

FIG. 1 is a schematic block diagram of a communication system connecting portable communicating objects, a campaign server managed by a network operator and a presence server for implementing the downloading method according to the invention;

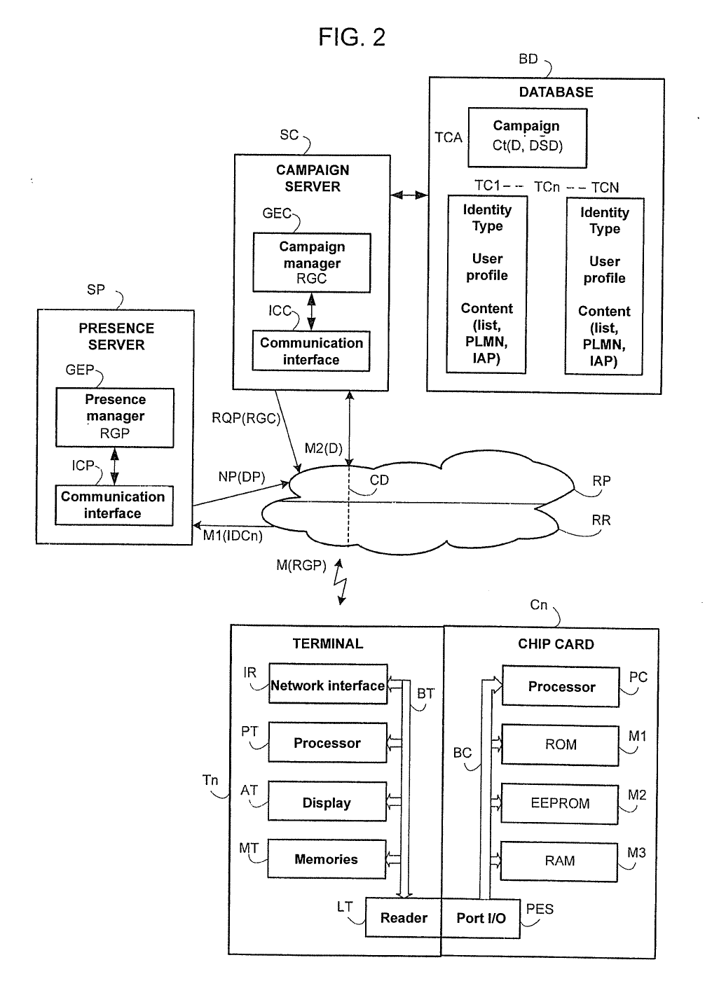

FIG. 2 is a more detailed schematic block diagram relating to FIG. 1; and

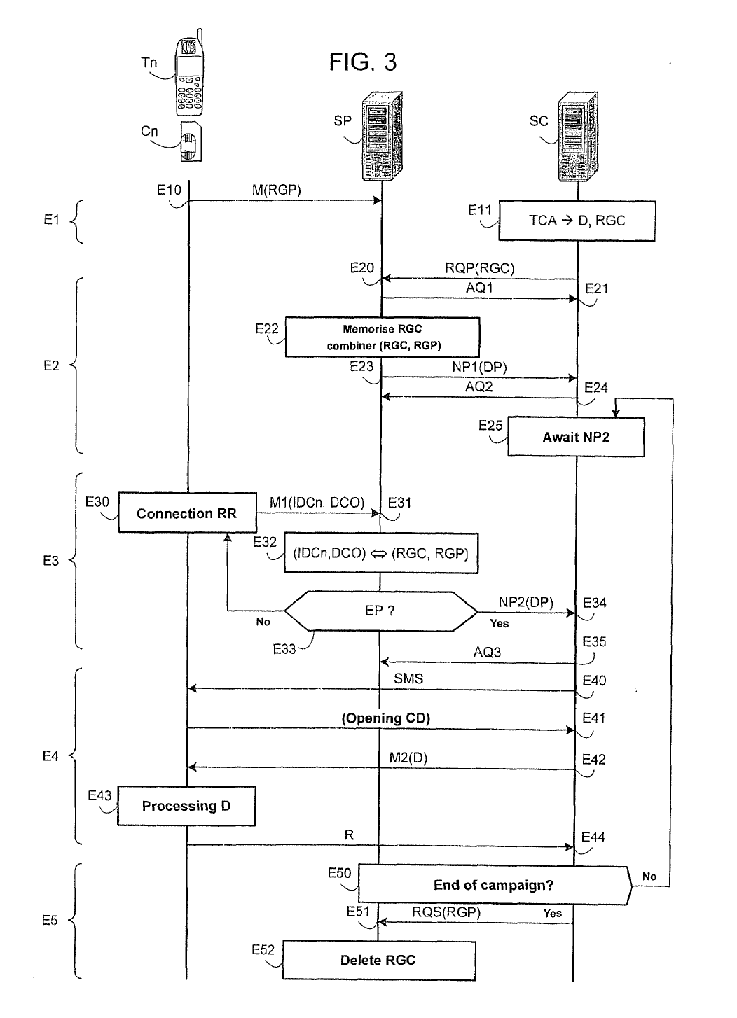

FIG. 3 is an algorithm of the downloading method according to the invention.

FIG. 1 depicts principal means for downloading data into portable communicating objects, such as removable usable chip cards C1-CN, which are associated respectively with mobile radio terminals T1-TN, attached to a digital cellular radio communication network RR. The chip card Cn associated with the mobile terminal Tn, with the index n such that 1≦n≦N, is of the UICC (Universal Integrated Circuit Card) type.

A campaign server SC according to the invention is in general managed by the operator of the network RR and constitutes an OTA (over the air) platform comprising data to be downloaded to the chip cards targeted by a downloading campaign.

A presence server SP detects in the radio communication network RR the presence of chip cards targeted by the downloading campaign according to campaign rules RGC prepared and transmitted to the server SP by the campaign server Sc. The campaign rules RGC are described in more detail with reference to FIG. 2.

The campaign server Sc and the presence server SP communicate with each other by a first data channel of a packet network RP of the internet or intranet type. According to the first case, the two servers Sc and SP are located at the same operator, thus reducing problems of IP addressing and name resolution. According to the second case, the two servers are located at distinct operators and then communicate by a secure connection between the two servers.

The campaign server Sc communicates with the chip card C1 to CN associated with the terminal T1 to TN by a second data channel CD open between the radio communication network RR and the packet network RP by means for example of a communication gateway not shown in FIG. 1. This second data channel CD does not pass through the present server SP. The communication gateway may comprise an access gateway for communicating with server SC through the high-rate packet network RP such as the internet, or such as an intranet network particular to the operator of the network RR. Another access gateway of the communication gateway communicates with at least one switch of the radio communication network, very often through an access network such as a packet network of the X.25 type.

According to a particular embodiment, the communication gateway exchanges, with the mobile radio terminals T1 to TN, messages that encapsulate IP (internet protocol) packets transmitted to and by the server SC over the networks RR and RP.

According to the embodiment illustrated in FIG. 1, when a campaign is launched the campaign server SC transmits a presence request RQP comprising campaign rules RGC to the present server SP via the packet network RP. As soon as a campaign rule RGC applied to a chip card Cn is satisfied in the presence server SP, the latter transmits a presence notification NP comprising an identifier IBCn for the card Cn to the campaign server SC so that the latter downloads data D into the chip card Cn.

The various steps of the method are detailed further with reference to the description of FIG. 3.

FIG. 2 depicts the campaign server SC, the presence server SP, the terminal Tn and the chip card Cn in the form of functional blocks, the majority of which fulfil functions having a link with the invention and may correspond to software and/or hardware modules.

The campaign server SC comprises a campaign manager GEC that manages various operations during the downloading and a communication interface ICC for transmitting and receiving packets IP over the packet network RP. The campaign manager GEC in particular prepares the campaign rules RGC relating to one or more downloading campaigns to be transmitted to the presence server.

A campaign rule RGC is linked to an unambiguous identification of a presence event for a chip card Cn targeted by the campaign in the radio communication network RR, which means that the card Cn is available in the network for sufficient time to receive a complete downloading of data from the campaign server SC. The campaign rule RGC includes at least one identifier IDCn for a chip card Cn targeted by a campaign, such as a serial number of the card or an international identity IMSI (international mobile subscriber identity) of the card user, and at least one presence condition. For example, the presence condition for the chip card Cn in the radio communication network RR is a connection of the chip card comprising the identifier IDCn to the radio communication network RR for a predetermined period typically more than five minutes. A presence event EP for the chip card targeted is detected by the presence server SP as soon as the presence condition included in the campaign rule transmitted from the campaign server to the presence server is satisfied. In general, a campaign rule RGC includes the identifiers of numerous chip cards targeted by a campaign and one or more presence conditions. According to another example, a presence condition is a location of the terminal supporting the chip card in a location zone in the network RR.

The campaign server SC is linked to a data base DD including various parameters and characteristics of the cards managed by the operator of the communication network RR. These parameters and characteristics are amongst other things necessary for the preparation of the campaign rules RGC.

Each chip card Cn is associated with a table TCn in the database BD. The table TCn comprises in particular initial characteristics that are linked to the identity of the card Cn and to the type of card and which are recorded in the database BB as soon as the card is brought into service. These initial characteristics are in particular a serial number of the card, the international identity IMSI (international mobile subscriber identity) of the user of the card and the telephone number of the mobile user MSISDN (mobile station ISDN number). The type of card Cn is defined in particular by an identifier of the type of processor included in the card, the identifier of the card manufacturer, a number of bits per word processed by the processor, characteristics of the operating system and of the virtual machine implemented in the card, etc.

Other characteristics particular to the use of the card and in particular the user of the card may also be recorded in the table TCn associated with the card Cn when the card is brought into service, and may be modified during the use of the card. These other characteristics concern in particular the subscription profile of the user of the card Cn, data that may be modified by the user or by the operator managing the card such as a list of telephone numbers and email addresses, and for example a file of identifiers for preferred radio communication networks PPLMN (preferred public land mobile network). These networks identified in the PPLMN file are managed by operators with whom the operator of the network RR to which the card Cn is attached has made agreements so that the user of the card Cn communicates through these networks when the user is moving over territories covered by these networks.

The table TCn may also contain one or more application identifiers IAP that were loaded when the chip card Cn was brought into service and/or were downloaded subsequently to its being brought into service. For example, an application consists of modifying the preferred network identifier file PPLMN. According to another example, the application consists of deleting or downloading an application in the card Cn for example to facilitate the management of the list of telephone numbers in the card Cn by enabling the user, whenever he records a new telephone number in the card, to save his entire list in a specific server managed by the operator so that the user can find his saved list when he loses the card Cn or when he changes card. Another application may serve the modified parameters in an application already downloaded in the card Cn; for example the parameters to be modified are an updating of reloading tariffs and communication units when the user is subscribed to a pre-paid account, or the updating of an advertising name of the operator or one of his services.

The database BD, or in a variant the server SC, also contains one or more campaign tables TCA respectively attributed to campaigns. Each campaign table TCA includes one or more contents Ct to be downloaded to the cards. Each content Ct contains data D to be downloaded. The data are for example data for updating an application, or an advertising message. Each content Ct also contains a description DSD of the data D such as the identifier IAP of the application to which the downloading relates or the list of identifiers of chip cards targeted by the downloading campaign TCA.

The database BD can be incorporated in the campaign server SC, or be independent in the form of a database management server that is connected to the server SC by a packet network such as the network RP (via the internet or via an intranet network) particular to the operator of the network RR.

The presence server SP comprises a presence manager GEP that manages various operations relating to the detection of presence events for chip cards in the radio communication network RR and satisfying one or more campaign rules RGC.

The presence server comprises in the presence manager presence rules RGP programmed by users subscribing to a presence service and based on timed ranges of accessibility to user terminals. A user subscribing to a presence service programmes, according to his activities, timed ranges of calling his terminals during which another user can call him. For example, the subscribed user programmes the timed ranges of accessibility of three terminals; a fixed office telephone on which he wishes to be called between 8 am and 2 pm, a mobile terminal or electronic messaging on which he wants to be contacted between 2 pm and 7 pm and a fixed home telephone on which he wishes to be called after 7 pm and before 8 am. As soon as a second user calls the user subscribing to a fixed home telephone in the middle of the afternoon, the presence server is informed of this and either refers the call according to the programming of the timed call ranges by the subscribed user for example to his mobile terminal, or sends a message intended for the second user indicating to him the ways and means such as the address of the terminal and the timed range of accessibility of it. The subscribing user can transmit, via his mobile terminal or another communication device, a message M comprising the presence rules RGP to the presence server SP.

The presence server also comprises a communication interface ICP for transmitting and receiving packets IP over the packet network RP and receiving messages M that may be of the IP type transmitted by an element controlling the radio communication network RR in order to indicate that a chip card Cn comprising the identifier ICDn is connected to the network.

The terminal Tn contains a reader LT that is associated with an input/output port PES of the chip card Cn with or without electrical contact.

Apart from the card reader LT, the terminal comprises a processor PT, memories MT, a display AT such as a screen connected to or integrated with the terminal and associated in particular with a keypad connected to or integrated with the terminal, and a network interface IR. The various elements of the terminal are connected together by a bi-directional bus BT.

The chip card Cn comprises mainly, in integrated form, one or more microprocessors PC and three memories M1 to M3. The memory M1 is a non-rewritable memory of the ROM or Flash type including the card operating system. The memory M2 is a non-volatile memory of the EEPROM or Flash type in order in particular to memorise keys, identity numbers and other parameters of the profile of the user possessing the card, such as a PIN code and other security data. The memory M3 is of the RAM or SRAM type serving more particularly for the processing of data. The card Cn exchanges commands, or requests, and responses with the terminal Tn through an input/output port PES and the reader LT with or without contact. The various elements of the card are connected together with a bi-directional bus BC.

With reference to FIG. 3, the downloading method according to the convention comprises steps E1 to E5.

Step E1 comprises mainly two initial steps E10 and E11.

At the initial step E10, the terminal Tn of a user subscribing to the presence service sends a message M comprising presence rules RGP relating to the timed ranges of accessibility for calling terminals of the subscribing user. These rules RGP may be transmitted via another communication device.

At the initial step E11, the operator of the radio communication network RR makes available one or more contents CT in the database BD, the data D must be downloaded during a campaign TCA of common operations of downloading data from the campaign server C to a set of cards specified according to the data descriptions DSD. The campaign manager GEC in the campaign server translates the descriptions DSD relating to the campaign TCA into identifiers of chip cards targeted by the campaign TCA and associates them with presence conditions in order to obtain campaign rules RGC understandable to the presence server SP. This is because a description of a downloading campaign requiring the updating of an application in cards may comprise only the identifier IAP of the application. The presence server, not being connected to the database BD of the campaign server, is ignorant of the content of the chip cards that are deemed to be present in the radio communication network.

Step E2 relates to the transmission of the rules RGC of the campaign TCA from the communication interface ICC of the campaign server SC to the communication interface ICP of the presence server SP by means of the first data channel and comprises steps E20 to E25.

At step E20, when the campaign TCA is initiated, the campaign server SC that prepared the campaign rules RGC relating to the campaign TCA transmits to the presence server SP a presence request RQP comprising a campaign rule RGC. On reception of the request RQP, the presence server may return an acknowledgement AQ1 at step E21. The campaign server transmits as many requests RQP as there are campaign rules. In a variant, the campaign server transmits only one presence request comprising a list of campaign rules.

After reception of all the campaign rules RGC the presence manager GEP stores them in a presence server SP, at step E22, combining them with the presence rules RGP already stored and relating to the timed ranges of accessibility of the terminals of the users possessing a chip card targeted by the campaign TCA. Thus, if a chip card Cn satisfies a campaign rule RGC but does not satisfy a presence rule RGP relating to the timed range of accessibility of the terminal Tn, the associated presence event EP will not be triggered. For example, a campaign rule comprises the following conditions: a chip card Cn comprising an identifier IDCn has been connected to the radio communication network RR for more than five minutes. If at 11.55 am the chip card Cn targeted by the campaign is connected to the radio communication network RR and a presence rule RGP indicates that at 12 noon the user of the said chip card will disconnect the terminal Tn containing the card from the network RR, the presence event EP is not triggered and the presence manager GEP does not detect it.

At step E23, the presence server SP optionally transmits to the campaign server SC a notification NP1 indicating amongst other things that the campaign rules transmitted have been stored correctly. The campaign server can return an acknowledgement AQ2 to the presence server at step E24.

At step E25, the campaign server SC awaits a new presence notification NP2 comprising presence data DP corresponding for example to the identifiers of the chip cards which have just been connected to the radio communication network RR and which comply with the rules RGC and RGP.

In a variant, the first notification NP1 can include presence data DP indicating to the campaign presence server SC the chip cards already present in the radio communication network RR when the campaign Tc was launched and complying with the campaign and presence rules. In this variant, the method continues with step E4 for each chip card complying with the said rules.

Step E3 corresponds to the detection of a presence event EP by the presence server SP, the event EP corresponding to the connection of a chip card Cn to the radio communication network RR and the card Cn complying with the campaign rules RGC and the presence rules RGP if these are stored in the present server and correspond to the card.

At step E30, at least the chip card Cn connects to the network RR and the connection of the chip card Cn is detected by a control device included in the radio communication network RR. The control device may be the nominal location register HLR (home location register) of the network RR. The control device transmits to the presence server SP, at step E31, a message M1 comprising the identifier IDCn of the card Cn connected and connection data DCO relating to the connection of the card. A connection data item DCO indicates for example the moment of connection of the card. The message M1 may be transmitted to the presence server SP according to a predefined periodicity.

On reception of the message M1, the presence manager GEP of the presence server SP, at step E32, makes the identifier IDCn of the card Cn and the connection data DCO correspond to the campaign rules RGC combined with the presence rules RGP designated by the card identifier IDCn. If the campaign and presence rules applicable to the card Cn thus identified by the identifier IDCn are complied with by the data DCO, a presence event EP is considered detected by the manager GEP at step E33. The presence server SP transmits to the presence server SC, at step E34, a presence notification NP2 comprising presence data DP relating to the chip card Cn complying with the rules RGC and RGP. The campaign server can return an acknowledgement AQ3 to the presence server and then proceeds with the downloading of the data D into the chip card Cn at step E4.

In the case where at least one of the combined rules RGC and RGP are applicable to the card Cn is not complied with, the campaign server SC is not acted on by a notification NP2. The presence server SP awaits compliance with the campaign and presence rules by the card Cn or any other card and the method passes from step E33 to the connection step E30.

Step E4 initiated by the detection of the presence event EP concerns the downloading of the data D by the campaign server SC into the chip card Cn, which complies with at least one campaign rule RGC via the second data channel CD not passing through the presence server SP.

At step E40 the campaign server transmits a message such as an SMS to the chip card in order to initiate the opening of the second data channel CD. The message SMS contains an address of the campaign server SC.

As soon as the card has received the SMS message, it opens, at step E41, by means of terminal Tn, the data channel CD of the IP type between the terminal Tn and the gateway between the networks RR and RP in order to initiate a session to communicate directly with the campaign server SC.

At step E42, the campaign server SC downloads the data D defined in the campaign TCA into the card Cn, which processes them at step E43. For example, the card updates an application to which the downloading relates. After processing of the data D, the card transmits, at step E43, the result of the downloading to the campaign server SC. At the end of downloading, the server SC closes the session, for example by sending a session closure request to the card Cn. On reception of the second closure request, the card and/or the campaign server SC release the communication channel CD between the terminal Tn and the gateway.

In a variant, the campaign server connects directly to the card by a connection of the IP type via a pre-defined port of the terminal Tn when the latter is for example a personal computer already offering internet or intranet connections.

Step E5 corresponds to the end of the campaign TCA once all the chip cards targeted have been processed.

At step E50, the campaign server checks whether all the chip cards targeted by the campaign TCA have been processed. If cards have not yet been processed, the campaign server awaits other presence notifications NP2 coming from the presence server at step E25. If all the cards targeted by the campaign have been processed, the campaign TCA is terminated and the campaign server at step E51 transmits a campaign rule deletion request RQS. On reception of the request RQS the presence server SP deletes all the rules RGC relating to the campaign TCA at step E52.

In a variant, the campaign rules relating to chip cards already processed can be deleted while the campaign TCA is not terminated.

The invention is not limited to a downloading of data into chip cards of the UICC type. A chip card in which data are to be downloaded can also be a card included in a portable computer connected to a mobile terminal or a payment card, an electronic purse card or any other additional card linked to a mobile terminal. According to other variants, the invention applies to other portable communicating electronic objects such as communicating personal digital assistants PDA. The invention also applies to mobile terminals aimed at by a campaign for which the data to be downloaded may concern a game to be recorded in a non-volatile memory of the EEPROM type of the mobile terminals.

The invention described here concerns a method and system for downloading data made available in a campaign server to portable communicating objects. According to a preferred implementation, the steps of the method of invention are determined by the instructions of the computer program incorporated in the system and in particular partly in the campaign server and partly in the presence server. The program contains instructions which, when the said program is loaded and executed in the system, whose function is then controlled by the execution of the program, perform the steps of the method according to the invention.

Consequently the invention also applies to a program, in particular a program on or in an information carrier, adapted to implement the invention.

1. A method for downloading data made available in a campaign server to portable communicating objects over a radio communication network comprising a presence server detecting the presence of communicating objects in the network during a data downloading campaign, comprising the steps of:
transmitting campaign rules relating to the campaign from the campaign server to the presence server, and
notifying by the presence server to the campaign server that an event relating to the presence of at least one communicating object in the radio communication network satisfies a transmitted campaign rule in order to initiate a downloading of the data from the campaign server to said communicating object.

2. A method according to claim 1, wherein a campaign rule includes at least one identifier of a communicating object targeted by the campaign and at least one presence condition for the communicating object in the radio communication network.

3. A method according to claim 1, wherein a presence condition for the communicating object in the radio communication network is a connection of the communicating object to the radio communication network for a predetermined period.

4. Method according to claim 1, wherein, after transmission of the campaign rules by the campaign server to the presence server, the presence server combines each campaign rule relating to a targeted communicating object with presence rules relating to at least one timed range of accessibility of said targeted communicating object so that an event relating to the presence of the targeted communicating object in the radio communication network satisfies both the campaign rules and the presence rules.

5. Method according to claim 1, wherein when the campaign is terminated the campaign rules are deleted in the presence server.

6. Method according to claim 1, wherein the said are downloaded by the campaign server to said communicating object via a data channel not passing through the presence server.

7. System for downloading data made available in a campaign server to portable communicating objects through a radio communication network comprising a presence server detecting the presence of communicating objects in the network, during a data downloading campaign, comprising:
a means in the campaign server for transmitting campaign rules relating to the campaign to the presence server, and
a means in the presence server for notifying to the campaign server that an event relating to the presence of at least one communicating object in the radio communication network satisfies a campaign rule in order to initiate a downloading of the data from the campaign server to said communicating object.

8. System according to claim 7, wherein the communicating objects are removable user chip cards from mobile terminals.

9. A system according to claim 7, wherein the communicating objects are mobile terminals.

10. A system according to claim 7, wherein the radio communication network is a code distribution multiple access network.

11. A computer-readable medium having encoded therein a program able to be implemented in a system for downloading data made available in a campaign server to portable communicating objects over a radio communication network comprising a presence server detecting the presence of communicating objects in the network, during a data downloading campaign, said program comprising instructions which, when the program is executed in said system, perform the following steps:
Transmitting campaign rules relating to the campaign from the campaign to the presence server, and
notifying by the presence server to the campaign server that an event relating to the presence of at least one communicating object in the radio communication network satisfies a campaign rule in order to initiate a downloading of the data from the campaign server to said communicating object.
